(19) United States
(12) Patent Application Publication
(10) Pub. No.: US 2021/0038027 A1
(43) Pub. Date: Feb. 11, 2021

(54) PORTABLE HERB/SPICE GRINDER

(71) Applicant: Zachary McCreedy, Norfolk, VA (US)

(72) Inventor: Zachary McCreedy, Norfolk, VA (US)

(21) Appl. No.: 16/941,211

(22) Filed: Jul. 28, 2020

Related U.S. Application Data
(60) Provisional application No. 62/883,289, filed on Aug. 6, 2019.

(51) Int. Cl. A47J 42/46; A47J 42/30; A47J 42/24; A47J 42/40

(52) U.S. Cl. CPC A47J 42/46; A47J 42/40; A47J 42/24; A47J 42/30

(57) ABSTRACT

A grinder includes a first tube having a first open end and a first floor with an annular recess at a perimeter thereof. First blades are coupled to the first floor and a first ring is disposed in the annular recess. A second tube has a second open end and a second floor. The second tube is configured for partial axial insertion in the first tube. Second blades are coupled to the second floor. When the second tube is inserted into the first tube, portions of the first blades are in a non-contact meshed engagement with portions of the second blades that supports relative rotation between the first and second tubes. A second ring disposed about the second tube is axially spaced from the first ring when the second tube is inserted into the first tube. The first and second rings comprise materials that are magnetically attracted to one another.

Pursuant to 35 U.S.C. § 119, the benefit of priority from provisional application 62/883,289, with a filing date of Aug. 6, 2019, is claimed for this non-provisional application.

### FIELD OF THE INVENTION

The invention relates generally to grinders, and more particularly to a portable grinder for grinding plant material such as herbs or spices.

### BACKGROUND OF THE INVENTION

Whole-leaf herbs and spices and/or other types of plant material are typically ground prior to their use. For reasons of practicality and cost, a good herb/spice grinder should be a hand-held and manually-operated device. Further, a good herb/spice grinder should efficiently grind all material and not be subject to clogging with any ground or unground material.

### SUMMARY OF THE INVENTION

Accordingly, it is an object of the present invention to provide a portable herb and/or spice grinder.

Another object of the present invention to provide a grinder that efficiently grinds all material placed in its grinding volume.

Other objects and advantages of the present invention will become more obvious hereinafter in the specification and drawings.

In accordance with the present invention, a grinder includes a first tube having a first open end and a first floor. The first floor has an annular recess therein at a perimeter thereof. First grinding blades are coupled to the first floor and extend towards the first open end. A first ring is disposed in the annular recess of the first floor. A second tube has a second open end and a second floor. The second tube is configured for partial axial insertion in the first tube via its first open end. Second grinding blades are coupled to the second floor and extend towards the second open end. When the second tube is inserted into the first tube, portions of the first grinding blades are in a non-contact meshed engagement with portions of the second grinding blades. The non-contact meshed engagement supports relative rotation between the first tube and second tube. A second ring is disposed about a perimeter of the second tube wherein, when the second tube is inserted in the first tube, the second ring is fitted within the first tube and is axially spaced from the first ring. The first ring and second ring comprise materials that are magnetically attracted to one another.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a side view of a portable herb/spice grinder in accordance with an embodiment of the present invention;

FIG. 2 is an axial cross-sectional view of the grinder taken along line 2-2 in FIG. 1;

FIG. 3 is an exploded cross-sectional view of the grinder;

FIG. 4 is an axial end view of the first grinding section taken along line 4-4 in FIG. 3;

FIG. 5 is an isolated perspective view of the first grinding section illustrating the grinding blades therein;

FIG. 6 is an axial end view of one end of the second grinding section taken along line 6-6 in FIG. 3;

FIG. 7 is an isolated perspective view of the second grinding section illustrating the grinding blades therein;

FIG. 8 is an axial end view of the other end of the second grinding section taken along line 8-8 in FIG. 3; and

FIG. 9 is a cross-sectional view of a removable storage compartment liner incorporating a conical de-bowling spike in accordance with another embodiment of the present invention.

### DETAILED DESCRIPTION OF THE INVENTION

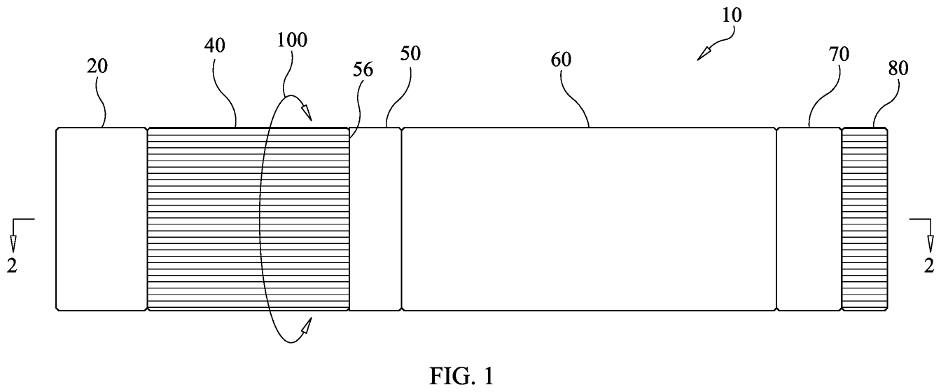

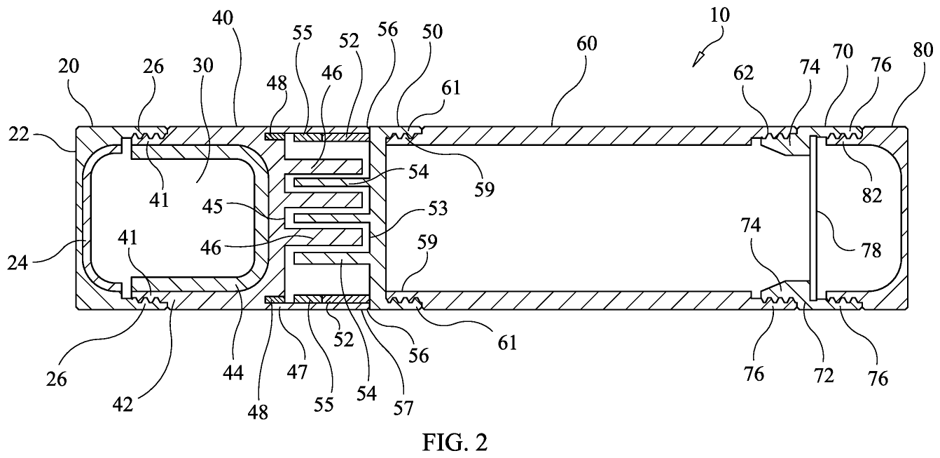

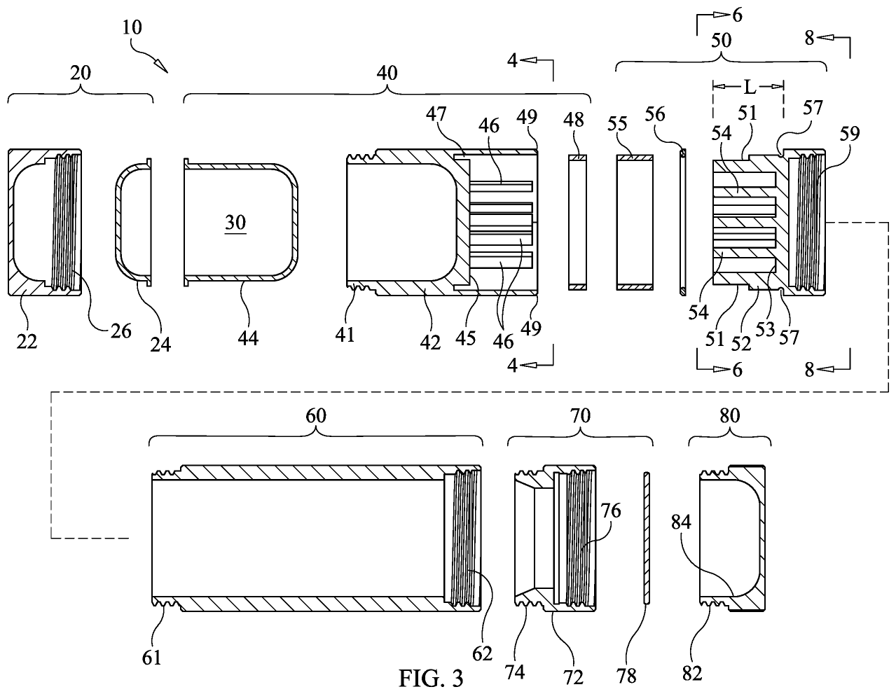

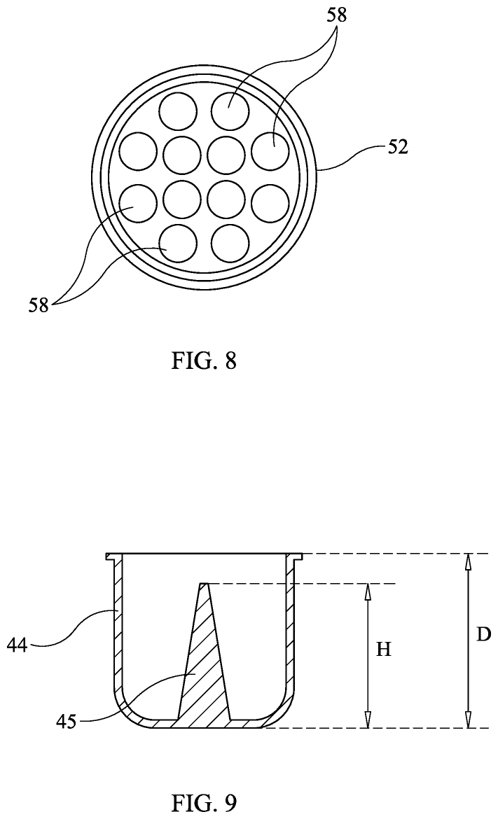

Referring now to the drawings, simultaneous reference will be made to FIGS. 1-8 where a portable herb/spice grinder in accordance with an embodiment of the present invention is shown assembled in FIGS. 1 and 2, in an exploded view thereof in FIG. 3, and in isolated portions thereof in FIGS. 4-8. The grinder in its assembled state is referenced generally by numeral 10.

As will be explained further below, grinder 10 is a portable and manually-operated device that remains clog-free during the grinding of leaf and/or plant portions of herbs and spices (not shown). Grinder 10 is assembled into a cylindrical assembly of threaded sections. However, it is to be understood that the present invention is not limited to a cylindrical or tubular shape and that sections thereof can be coupled to one another in other ways without departing from the scope of the present invention. Grinder 10 includes an end cap 20 for a storage compartment 30, a first grinding section 40, a second grinding section 50, a ground material storage cylinder 60, a dust screen assembly 70, and an end cap and dust collector 80. Briefly, to grind material, sections 40 and 50 are rotated about their central longitudinal axes relative to one another as indicated by rotational arrow 100.

End cap 20 defines one end of grinder 10 and includes an outer shell 22 and an inner liner 24. Outer shell 22 can be any rigid material, while inner liner 24 can be a removable cup as in the illustrated embodiment, or a permanently adhered lining material without departing from the scope of the present invention. Inner liner 24 could be a non-stick material or coating such as glass, a silicone-based material, or a non-stick material such as polytetrafluoroethylene or PTFE which is available commercially under the trademark TEFLON. The use of PTFE for inner liner 24 provides a chemically inert interface with any herb or spice material it comes into contact with, and also presents a surface having a very low coefficient of friction to prevent herb or spice material from sticking thereto. End cap 20 is internally threaded at 26 for engagement with corresponding threads 41 on first grinding section 40.

First grinding section 40 is externally threaded at 41 for engagement with threads 26 of end cap 20. First grinding section 40 includes an outer tubular shell or casing 42 made from a rigid non-magnetic material (e.g., aluminum, plastic, composite, etc.). The axial end of first grinding section 40 adjacent to threads 41 is open and hollowed out to define an open-ended tubular volume that supports a removable liner/cup 44, or a fixed inner liner or coating. In either case, liner 44 can be a non-stick material such as glass, a silicone-based material, or a non-stick material such as PTFE. The use of PTFE for inner liner/cup 44 provides a chemically inert interface with any herb or spice material it comes into contact with, and also presents a surface having a very low coefficient of friction to prevent herb or spice material from sticking thereto. When end cap 20 is threadably coupled to first grinding section 40, compartment 30 becomes a sealed and axially-aligned storage tube by the mating of liners 24 and 44 (FIG. 2). Compartment 30 can be used, for example, to hold unground or other material (not shown). If liners 24 and 44 are constructed to mate or contact one another (as shown) and are made from a silicone-based material or PTFE, the liners combine to form an air-tight and water-tight container to preserve the freshness of material contained within compartment 30.

The opposing axial end of first grinding section 40 is also open and hollowed out to define an open-ended tube extending to a floor 45. Coupled to floor 45 is a plurality of grinding blades 46 extending axially away from floor 45 within tubular casing 42. In general, blades 46 do not extend beyond the open end of casing 42. However, the specific number, size, and/or shape of grinding blades 46 are not limitations of the present invention. Floor 45 includes an annular recess 47 at the perimeter of floor 45. Mounted in recess 47 is a ring 48 made from magnetic or magnetically-attractive material such as steel. Ring 48 can be press-fit into recess 47 or otherwise fixed in place in ways well understood in the art. Ring 48 can be flush with floor 45 or non-flush with respect thereto without departing form the scope of the present invention. The purpose of ring 48 will be explained further below. The outside surface of outer tubular casing 42 can be knurled (as shown) for enhanced gripping.

Second grinding section 50 is also made from a rigid non-magnetic material such as aluminum, plastic, composite, etc. Second grinding section 50 has an outer tubular shell or casing 52. One axial end of second grinding section 50 is hollowed out to define an open-ended tube extending to a floor 53. Coupled to floor 53 is a plurality of grinding blades 54 extending axially away from floor 53 within tubular casing 52. In general, blades 54 do not extend beyond the open end of casing 52. However, the specific number, size, and/or shape of grinding blades 54 are not limitations of the present invention.

In general, grinding blades 46 and 54 are configured to be in close proximity to one another when a portion of second grinding section 50 is inserted axially into a portion of first grinding section 40 as shown in FIG. 2. More specifically, when section 50 is inserted into section 40, portions of blades 46 and 53 are in a non-contact mesh arrangement that assures that blades 46 do not contact blades 54 when sections 40 and 50 are stationary and when sections 40 and 50 are rotated relative to one another. A variety of configurations for blades 46 and 54 can be used without departing from the scope of the present invention.

Coupled to the open axial end of second grinding section 50 to which blades 54 extend is a ring-shaped magnet 55. For example and in the illustrated embodiment, magnet 55 is disposed about the axial end of second grinding section 50 that fits inside the hollowed-out open tube portion of first grinding section 40 housing grinding blades 46. Magnet 55 can be press-fit onto an annular ledge 51 defined at the open-ended tube of casing 52. Magnet 55 could also be adhered to casing 52 or made integral therewith without departing from the scope of the present invention.

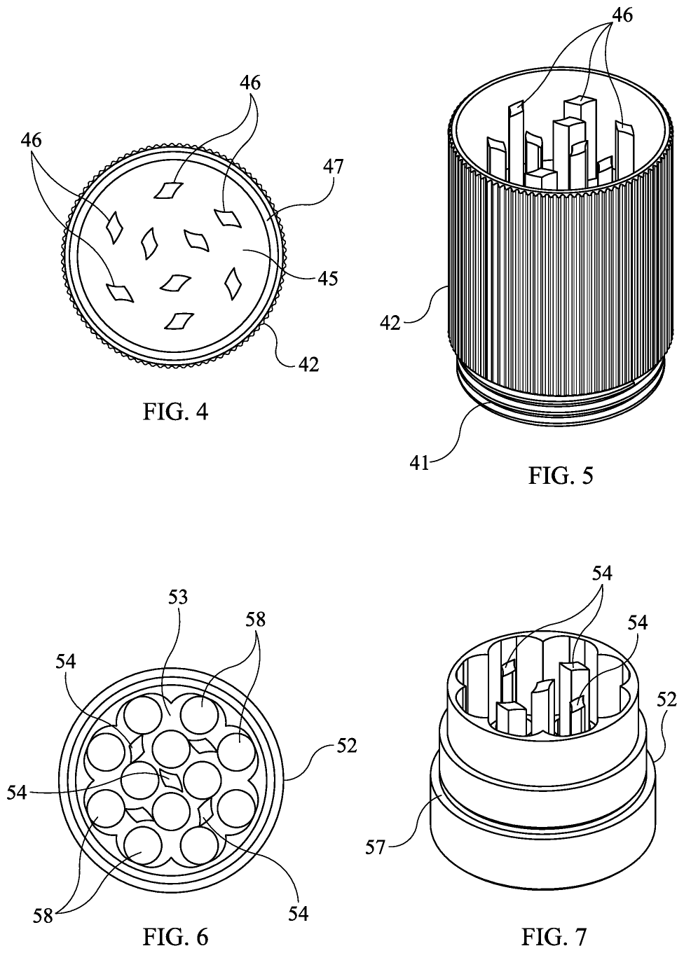

The axial length “L” (FIG. 3) of the portion of casing 52 inserted into section 40 is such that ring 48 and magnet 55 are in a magnetically-attractive, but non-contact axially-opposed relationship when sections 40 and 50 are assembled. That is, ring 48 and magnet 55 are close enough to have an attraction force there between that is sufficient enough to keep sections 40 and 50 engaged with one another, while also permitting relative axial rotation 100 between sections 40 and 50. The annular magnetic engagement of magnet 55 with ring 48 keeps the grinding volume of grinder 10 air and water tight, while also allowing the grinding volume to have an efficient arrangement of grinding blades unencumbered by any attachment mechanism or scheme. To fine tune the axial spacing between ring 48 and magnet 55 and/or reduce rotational friction between sections 40 and 50, a ring 56 of anti-friction material (e.g. TEFLON) can be placed on an axial ledge 57 of second grinding section 50. Ring 56 provides an anti-friction contact surface with the outboard end 49 of section 40 when sections 40 and 50 are held together via the magnetic attraction between magnet 55 and ring 48. Finally and as illustrated in FIG. 6, floor 53 incorporates a number of through holes 58 through which ground material (not shown) can pass through.

Ground material storage cylinder 60 is an open-ended tube threaded at one axial end thereof as indicated at 61 for engagement with threads 59 on second grinding section 50, and threaded at the other axial end thereof as indicated at 62 for engagement with dust screen assembly 70. Ground material to include dust particles/residue passes through holes 58 and into storage cylinder 60. The size of storage cylinder 60 is not a limitation of the present invention.

Threadably coupled to storage cylinder 60 at threaded end 62 is dust screen assembly 70 that includes an open-tube outer shell 72 threaded at 74 to engage threaded end 62 of storage cylinder 60, and threaded at 76 to engage end cap and dust collector 80. Mounted in outer shell 72 is a dust screen 78 that allows very fine dust particles from storage cylinder 60 to pass into dust collector 80. Dust collector 80 is threaded at 82 for engagement with threaded end 76 of dust screen assembly 70. Dust collector 80 is hollowed out at 84 for collection of dust passing through dust screen 78.

In operation, sections 40 and 50 are simply separated by pulling them axially away from one another to overcome the magnetic attraction between ring 48 and magnet 55. Material to be ground is placed in section 50, and sections 40 and 50 are reassembled. Section 40 is then rotated relative to section 50 thereby grinding the material with the ground material passing through holes 58 into storage cylinder 60.

Although the invention has been described relative to a specific embodiment thereof, there are numerous variations and modifications that will be readily apparent to those skilled in the art in light of the above teachings. For example, the above-described recess 47 could be omitted and ring 48 could rest on and be coupled to the above-described floor 45. In other embodiments of the present invention, ring 48 could also be a magnet positioned for magnetic attraction to magnet 55 when sections 40 and 50 are joined. In still other embodiments of the present invention, ring 48 could be a magnet and magnet 55 could be replaced by a ring of a magnetically-attractive material such as steel.

In other embodiments of the present invention, the above-described removable cup-shaped inner liner 44 can also include a centrally-positioned axially-extending cone 45 as illustrated in FIG. 9. Cone 45 can be integral with the bottom of liner 44 or coupled thereto. Cone 45 can be used as a de-bowling spike when liner 44 with cone 45 is removed from the grinder of the present invention. In this way, cone 45 can be used, for example, to unclog smoking residue from a smoking device such as a vaporizer. The height “H” of cone 45 can be less than the depth “D” of the inside of liner 44 or greater than depth D without departing from the scope of the present invention. If height H is greater than depth D, cone 45 could also be used to de-bowl externally chambered smoking devices. It is therefore to be understood that, within the scope of the appended claims, the invention may be practiced other than as specifically described.

What is claimed as new and desired to be secured by Letters Patent of the United States is:

1. A grinder, comprising:
a first tube including a first open end and a first floor, said first floor having an annular recess therein at a perimeter of said first floor;
a plurality of first grinding blades coupled to said first floor and extending towards said first open end;
a first ring disposed in said annular recess of said first floor;
a second tube including a second open end and a second floor, said second tube configured for partial axial insertion in said first tube via said first open end;
a plurality of second grinding blades coupled to said second floor and extending towards said second open end wherein, when said second tube is inserted into said first tube, portions of said first grinding blades are in a non-contact meshed engagement with portions of said second grinding blades, and wherein said non-contact meshed engagement supports relative rotation between said first tube and said second tube;
a second ring disposed about a perimeter of said second tube wherein, when said second tube is inserted in said first tube, said second ring is fitted within said first tube and is axially spaced from said first ring; and
said first ring and said second ring comprise materials that are magnetically attracted to one another.

2. A grinder as in claim 1, further comprising holes passing through said second floor.

3. A grinder as in claim 2, further comprising:
a first storage compartment coupled to said first tube; and
a second storage compartment coupled to said second tube wherein said holes provide fluid communication between said second tube and said second storage compartment.

4. A grinder as in claim 3, wherein said first storage compartment is lined with a non-stick material.

5. A grinder as in claim 3, further comprising a removable cup fitted in said first storage compartment, said cup including a spike extending axially from a bottom of said cup.

6. A grinder as in claim 3, further comprising:
a filter disposed adjacent to said second storage compartment, said filter adapted to filter dust particles there through; and
a dust collector coupled to said filter for collecting the dust particles passing through said filter.

7. A grinder as in claim 1, further comprising a ring of anti-friction material in contact with annular portions of said first tube and said second tube during said relative rotation between said first tube and said second tube.

8. A grinder as in claim 1, wherein said first ring comprises a magnetic material, and wherein said second ring comprises a magnet.

9. A grinder as in claim 1, wherein said first tube and said second tube comprise non-magnetic materials.

10. A grinder, comprising:
a first tube of non-magnetic material, said first tube including a first open end and a first floor;
a plurality of first grinding blades coupled to said first floor and extending towards said first open end;
a ring of magnetic material coupled to a perimeter of said first floor;
a second tube of non-magnetic material, said second tube including a second open end and a second floor, said second tube configured for partial axial insertion into said first tube via said first open end;
a plurality of second grinding blades coupled to said second floor and extending towards said second open end wherein, when said second tube is inserted into said first tube, portions of said first grinding blades are in a non-contact meshed engagement with portions of said second grinding blades, and wherein said non-contact meshed engagement supports relative axial rotation between said first tube and said second tube;
a magnet coupled to said second open end wherein, when said second tube is inserted into said first tube, said magnet is fitted within said first tube and is axially spaced from said ring, wherein a magnetic force of attraction is established between said magnet and said ring.

11. A grinder as in claim 10, further comprising holes passing through said second floor.

12. A grinder as in claim 11, further comprising:
a first storage tube in axial alignment with and coupled to said first tube; and
a second storage tube in axial alignment with and coupled to said second tube wherein said holes provide fluid communication between said second tube and said second storage tube.

13. A grinder as in claim 12, wherein said first storage tube is lined with a non-stick material.

14. A grinder as in claim 12, further comprising a removable cup fitted in said first storage tube, said cup including a spike extending axially from a bottom of said cup.

15. A grinder as in claim 12, further comprising:
a filter disposed adjacent to said second storage tube, said filter adapted to filter dust particles there through; and
a dust collector coupled to said filter for collecting the dust particles passing through said filter.

16. A grinder as in claim 10, further comprising a ring of anti-friction material in contact with annular portions of said first tube and said second tube during said relative axial rotation between said first tube and said second tube.

17. A grinder, comprising:
a first tube including a first open end and a first floor, said first floor having an annular recess therein at a perimeter of said first floor;
a plurality of first grinding blades coupled to said first floor and extending towards said first open end;
a first ring disposed in said annular recess of said first floor;
a second tube including a second open end and a second floor having holes passing there through, said second tube configured for partial axial insertion in said first tube via said first open end;
a plurality of second grinding blades coupled to said second floor and extending towards said second open end wherein, when said second tube is inserted into said first tube, portions of said first grinding blades are in a non-contact meshed engagement with portions of said second grinding blades and wherein said non-contact meshed engagement supports relative rotation between said first tube and said second tube;
a second ring coupled to said second open end wherein, when said second tube is inserted in said first tube, said second ring is fitted within said first tube and is axially spaced from said first ring;
said first ring and said second ring comprising materials magnetically attracted to one another;
a first storage tube in axial alignment with and coupled to said first tube; and
a second storage tube in axial alignment with and coupled to said second tube wherein said holes provide fluid communication between said second tube and said second storage tube.

18. A grinder as in claim 17, wherein said first storage tube is lined with a non-stick material.

19. A grinder as in claim 17, further comprising a removable cup fitted in said first storage tube, said cup including a spike extending axially from a bottom of said cup.

20. A grinder as in claim17, further comprising:
a filter disposed adjacent to said second storage tube, said filter adapted to filter dust particles there through; and
a dust collector coupled to said filter for collecting the dust particles passing through said filter.

21. A grinder as in claim 17, further comprising a ring of anti-friction material in contact with annular portions of said first tube and said second tube during said relative rotation between said first tube and said second tube.

22. A grinder as in claim 17, wherein said first ring comprises a magnetic material, and wherein said second ring comprises a magnet.

23. A grinder as in claim 17, wherein said first tube and said second tube comprise non-magnetic materials.
